(19) United States
(12) Patent Application Publication
(10) Pub. No.: US 2025/0125872 A1
(43) Pub. Date: Apr. 17, 2025

(54) SYSTEMS AND METHODS PROVIDING PRELIMINARY ESTIMATION OF FIBER LENGTH

(71) Applicant: DZS Inc., Plano, TX (US)

(72) Inventor: Seung Dong Lee, Plano, TX (US)

(73) Assignee: DZS Inc., Plano, TX (US)

(21) Appl. No.: 18/913,521

(22) Filed: Oct. 11, 2024

Related U.S. Application Data
(60) Provisional application No. 63/589,528, filed on Oct. 11, 2023.

(51) Int. Cl. H04B 10/079; G01J 9/02

(52) U.S. Cl. CPC H04B 10/07955; G01J 9/0246

(57) ABSTRACT

Embodiments are directed to a preliminary estimation process, which may be used by an optical network device. The optical network device may preliminarily estimate a length of fiber in the network and, from that, may estimate a preliminary equalization delay. The optical network device may then transmit a message over the optical network according to the preliminary equalization delay.

### CROSS-REFERENCE TO RELATED APPLICATIONS

The present application claims the benefit of U.S. Provisional Patent Application 63/589,528, filed Oct. 11, 2023, the disclosure of which is hereby incorporated by reference in its entirety.

### TECHNICAL FIELD

The present disclosure relates to network device operation within an optical network and, more specifically, to systems and methods that preliminarily estimate fiber length.

### BACKGROUND

Optical networks, such as passive optical networks (PONs), have found widespread use in a variety of applications. For instance, residential and business Internet service providers may employ optical networks to transmit data to and from a home or business premises. In another example, wireless data service may include a radio unit that communicates with a central office through an optical network.

Optical networks may be chosen due to their high-bandwidth and low-latency characteristics. However, a particular area of improvement may include a discovery process when a network device is either turned on or otherwise introduced to a network, where the discovery processes may result in higher latency or otherwise delay data transmission.

### SUMMARY

Embodiments are directed to systems and methods for estimating a fiber length in an optical network or otherwise timing a response signal.

In one embodiment, a first optical network device includes an optical transceiver; a computing device in communication with the optical transceiver and configured to control transmission and reception at the optical transceiver; a memory storing computer readable media having computer executable code, which when executed by the computing device, causes the first optical network device to: receive a broadcast message from a second optical network device through an optical network and via the optical transceiver; acquire an estimate of fiber length associated with the optical network based on at least one of: a physical characteristic of the broadcast message or information carried by the broadcast message; determine a timing of a response message to be sent by the first optical network device and to be received during a time window at the second optical network device, wherein the timing of the response message is determined at least in part based upon the estimate of the fiber length; and transmit the response message via the optical transceiver to the second optical network device according to the timing.

In another embodiment, a method is performed by a first optical network device, the method including: broadcasting a discovery message over an optical network, the optical network including a second optical network device that has not yet been discovered by the first optical network device; maintaining a quiet window that is sized to accommodate a preliminary equalization delay associated with the second optical network device; receiving a response to the discovery message from the second optical network device within the quiet window; discovering the second optical network device; and performing a ranging process, the ranging process having a second level of uncertainty that is lower than a first level of uncertainty associated with the preliminary equalization delay.

In yet another embodiment, a method is performed by a first optical network device, the method including: receiving a broadcast message from a second optical network device, the broadcast message received over the optical network; determining a preliminary equalization delay for the first optical network device based on at least one of: a physical characteristic of the broadcast message or information carried by the broadcast message; transmitting the response message from the first optical network device to the second optical network device according to the preliminary equalization delay.

### BRIEF DESCRIPTION OF THE DRAWINGS

Having thus described the invention in general terms, reference will now be made to the accompanying drawings, which are not necessarily drawn to scale, and wherein:

FIG. 1 illustrates an example quiet window based on a minimum response time in a maximum response time in an optical network, according to one implementation.

FIG. 2 illustrates an example optical network in which various aspects of the present disclosure may be performed.

FIG. 3 illustrates an example technique for estimating fiber length by measuring skew, according to one implementation.

FIG. 4 illustrates an example unit skew, according to one implementation.

FIG. 5 illustrates an example reduced quiet window, corresponding to example preliminary equalization delays, according to one implementation.

FIG. 6 illustrates an example method that may be performed by a downstream optical network device, such as an optical network unit (ONU), according to one implementation.

FIG. 7 illustrates an example method that may be performed by an upstream optical network device, such as an optical line terminal (OLT), according to one implementation.

FIG. 8 illustrates an example optical network device, according to one implementation.

While the system of the present application is susceptible to various modifications and alternative forms, specific embodiments thereof have been shown by way of example in the drawings and are herein described in detail. It should be understood, however, that the description herein of specific embodiments is not intended to limit the system to the particular forms disclosed, but on the contrary, the intention is to cover all modifications, equivalents, and alternatives falling within the spirit and scope of the present application as defined by the appended claims.

### DETAILED DESCRIPTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

Various embodiments may be used to reduce a quiet window in an optical network. For instance, an optical network device, such as an optical network unit (ONU), may broadcast a discovery message during a discovery operation. A discovery operation may be performed for example when a new downstream optical network device, such as an optical line terminal (OLT), powers up or otherwise comes online. Fiber length between the new downstream optical device and the upstream optical device may affect a time of travel for a signal. For instance, the longer the fiber length, the more delay may be seen between transmission and reception of a given signal and, similarly, the more delay may be seen in a round trip signal and corresponding response.

Because of the delay attributable to the fiber length, and because the precise location of the downstream optical network device may be unknown, there may be uncertainty around the time that a response from the downstream optical network device would be received by the upstream optical network device. Accordingly, the upstream optical network device may maintain a quiet window, which is a time in which some traffic may be restricted to avoid collision with an expected and desired response message. In some current systems, the upstream optical network device maintains a quiet window corresponding to the full range of possible response arrival times.

The quiet window is one of the hurdles in the implementation of low latency time division multiplexing (TDM) in passive optical networks (PONs) for time sensitive applications, such as mobile fronthaul. A quiet window may be employed in the discovery process to address the uncertainty of the response delay. During an example discovery process, no already-discovered ONU is allowed to transmit a signal. The typical size of the quiet window is 100 us˜200 us, which exceeds the delay tolerance in the 5G mobile fronthaul transport. Therefore, it may be desirable to reduce the quiet window for some applications.

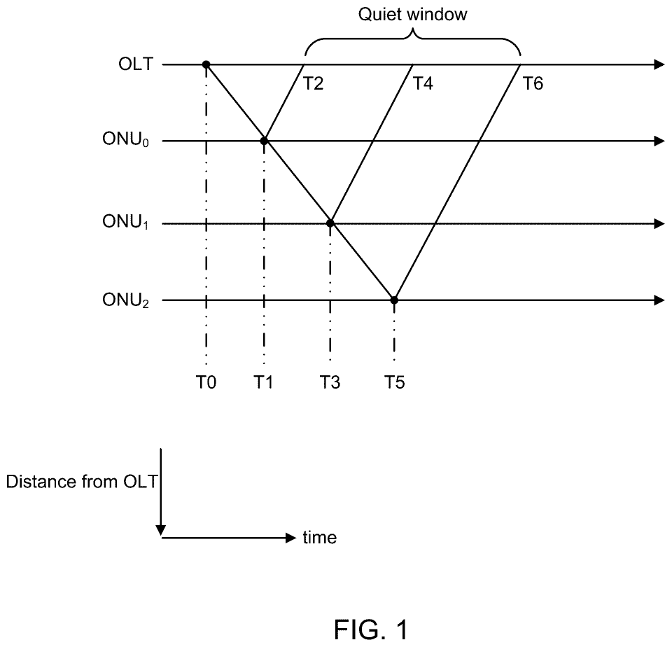

FIG. 1 illustrates an example arrangement of optical network units and a corresponding quiet window. The OLT is an upstream optical network device, and there are three ONU devices (ONU₀-ONU₂), which are examples of downstream optical network devices. In this particular illustration, the ONU devices are listed from top to bottom and have a relationship such that ONU₀ is closest to the OLT, ONU₁ is a second closest to the OLT, and ONU₂ is the furthest from the OLT. Further in this example, the term “closest” refers to a shorter fiber length, whereas “furthest” refers to a longer fiber length.

In other words, FIG. 1 is a graph in which the Y axis represents distance from the OLT. The X axis represents time. At time T0, the OLT broadcasts a discovery message over the wireless network. The discovery message reaches ONU₀ first at time T1. ONU₀ sends a response message, which reaches the OLT at time T2. At time T3, the discovery message reaches ONU₁, which sends a response message that reaches OLT at time T4. The discovery message reaches ONU₂ at time T5, and the response message of ONU₂ reaches the OLT at time T6.

Assuming a maximum fiber length of 20 km from the OLT to the furthest ONU₁, the maximum round-trip time may be around 200 μs, and a minimum round-trip time may even be close to 0 μs. Without any additional information, the OLT and the ONU devices assume a maximum amount of uncertainty and, therefore, the quiet window is set from time T2 (representing a minimum amount of round-trip time) to time T6 (representing a maximum amount of round-trip time), and the quiet window may be as large as 200 μs to accommodate time T2 to time T6.

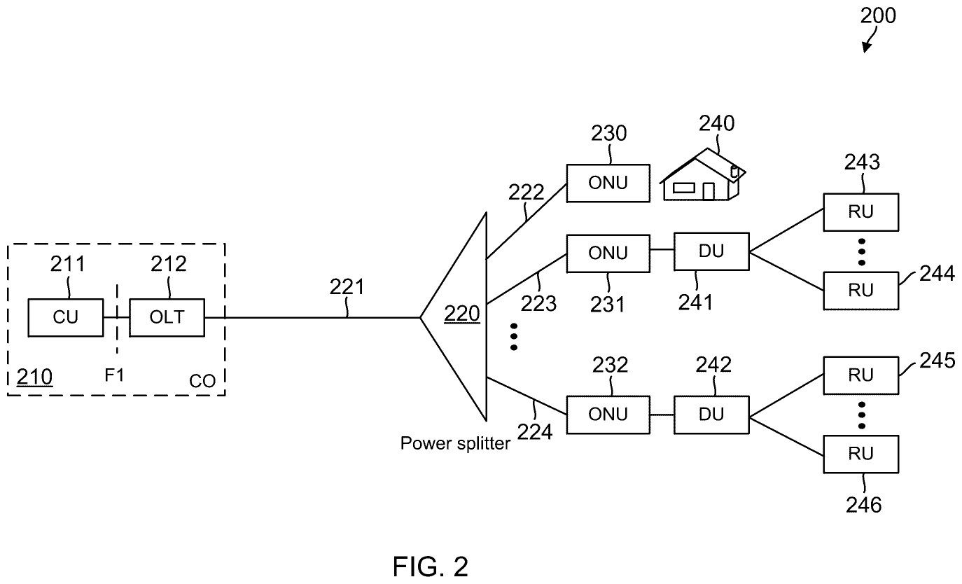

Of course, these distances and times are for example only. The scope of implementations associated with the embodiments illustrated in FIGS. 2-8 is not limited to any distance or time and in fact may be scaled to accommodate any appropriate optical network having any appropriate optical fiber length. Furthermore, some examples herein do not address a random time delay that may be added to a reply time of a given downstream optical network device, but it is understood that a random time delay may be included in some implementations and would be additive with respect to the round-trip time.

During the quiet window, traffic is restricted over the portion of the wireless network that includes the OLT. It may be advantageous in some aspects to shorten the quiet window. Shortening the quiet window may be expected to increase the efficiency of the network by increasing an amount of time in which signals may be transmitted. Furthermore, the quiet window may be seen as a delay to some applications (e.g., 5G applications) and may exceed a delay guideline for the applications. Therefore, shortening the quiet window may allow for less optical network delay to accommodate delay-sensitive applications.

Various embodiments may shorten the quiet window by configuring a downstream optical network device, such as an ONU, to preliminarily estimate fiber length based on the discovery message from the upstream optical network device, such as an OLT. Once the downstream optical network device has acquired the preliminary fiber length estimate, it may use that fiber length estimate to time its response to the discovery message so that the response arrives at the upstream optical network device within a shortened window.

After the upstream optical network device has received the response during the shortened window, it may proceed with the rest of the discovery process. In some examples, the upstream optical network device and the downstream optical network device may perform a two-way formal ranging process that provides a fiber length measurement that is more precise than the preliminary fiber length estimate. As described in more detail below, the formal ranging process may produce an equalization delay that is more precise than a preliminary equalization delay generated by the preliminary fiber length estimate.

FIG. 2 is an illustration of an optical network 200 in which various aspects of the present disclosure may be performed. FIG. 2 is directed to an example in which the optical network 200 is implemented to serve a 5G network. However, the scope of implementations is not limited to 5G applications, as it may be adapted into other applications, such as residential and business Internet, 6G and other enhancements to mobile data, and the like.

5G architecture is designed to deliver significantly higher data speeds, lower latency, and enhanced connectivity. The example of FIG. 2 includes a Central Unit (CU) 211 and an Optical Line Terminal (OLT) 212 located within a central office 210.

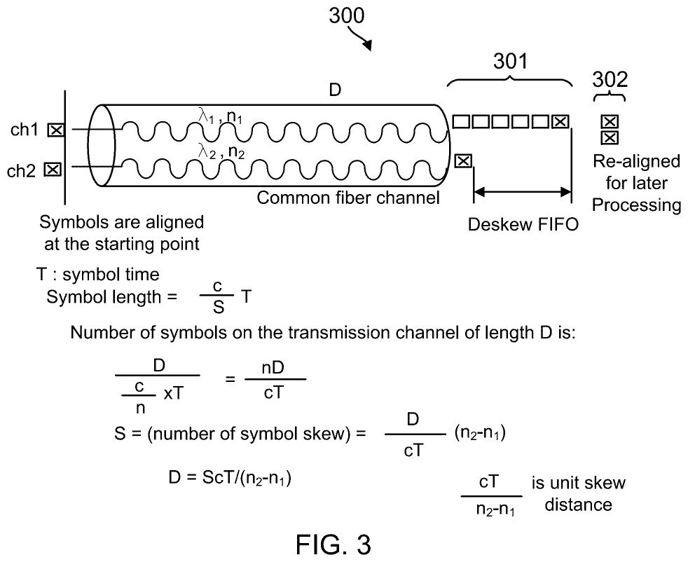

The CU 211 and OLT 212 are interconnected through an interface known as F1, which enables the efficient exchange of data and control signals. The OLT 212 serves as a gateway for the 5G network, transmitting signals to a power splitter 220, which distributes power among several Optical Network Units (ONUs) 230, 231, 232. In the present example, the OLT 212 and the ONUs 230-232 include enhancements that allow them to perform the actions described below and with respect to FIGS. 3-7. Specifically, the ONUs 230-232 may be configured to acquire preliminary estimates of the fiber length and to use those preliminary estimates to time response messages to arrive within a short window at the OLT 212. Furthermore, the OLT 212 may be configured to utilize the short window, as described further below.

With respect to the ONU 230, its fiber length estimate is associated with the lengths of fiber 221, 222. Similarly, with respect to ONU 231, its fiber length estimate is associated with lengths of fiber 221 and 223, and with respect to ONU 232, its fiber length estimate is associated with the lengths of fibers 221 and 224.

The ONUs 230-232 extend data connectivity to various locations. One such location includes residence 240, where ONU 230 is deployed for residential internet access, providing high-speed data service for one or more households. This residential ONU 240 may additionally or alternatively serve one or more businesses or institutions.

Another application of ONUs lies in their placement with Distributed Units (DU) 241, 242. DUs 241, 242 are positioned to be in contact with multiple Radio Units (RUs) 243-246 over Ethernet (or other appropriate) connections. Each DU 241, 242 acts as an intermediary, managing communication with its respective RUs and the upstream network elements, such as the OLT 212. This distributed architecture allows for enhanced coverage and capacity by bringing the RUs 243-246 closer to the end-users, reducing latency, and improving overall network performance.

FIG. 2 illustrates three ONUs 230-232, though the scope of embodiments may include any appropriate number of ONUs, as indicated by the ellipses. Similarly, the ONUs that are split from any given splitter may include all residential ONUs, all DU-connected ONUs, or a mix thereof. A given DU-connected ONU may be coupled to any appropriate number of downstream RUs.

FIG. 3 illustrates an example technique for estimating fiber length by measuring skew, according to one implementation. A common fiber medium is illustrated by fiber 300. The OLT (e.g., OLT 212) may transmit a signal having two different components. A first component ch1 is at a first wavelength λ₁, and the second component ch2 is at a second wavelength λ₂. Each of the different wavelengths λ₁ and λ₂ is associated with a distinct, respective refractive index n₁ and n₂.

The first and second components ch1 and ch2 traverse the length of the fiber 300 (i.e., fiber distance, D). The component having the lower refractive index traverses the length of the fiber 300 faster than does the component having the higher refractive index. As a result, a symbol transmitted on a component having the lower refractive index arrives at first in first out (FIFO) buffer 301 sooner than a symbol transmitted on the component having the higher refractive index. This is referred to as “skew” between the two optical signal components ch1, ch2. The FIFO buffer 301 may be a de-skew buffer, which aligns 302 the symbols, thereby compensating for the skew. In one implementation, an optical network device that receives the signal components ch1 and ch2 may measure the difference of buffer indices between a first symbol arriving on ch1 and a first symbol arriving on ch2 to determine an amount of skew.

The amount of time between a leading edge of a symbol to pass a particular point on the fiber and a trailing edge of the same symbol to pass the particular point on the fiber is referred to as “symbol time,” and it is represented by T. The amount of skew at the receiving buffer is given by S, and the speed of light is given by c. The amount of skew at the receiving buffer can be represented by Equation 1.

$$S = D * ( {n}_{2} - {n}_{1} ) / ( cT ) \qquad Equation 1$$

A unit skew distance is given by A in Equation 2 below.

$$A = cT / ( {n}_{2} - {n}_{1} ) \qquad Equation 2$$

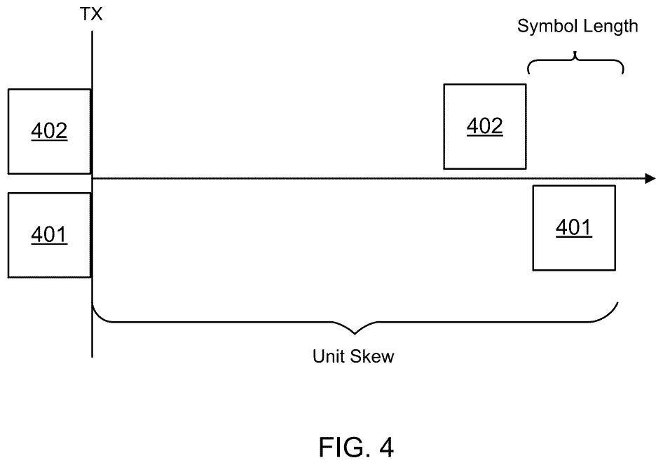

The concept of a unit skew is illustrated in FIG. 4. In FIG. 4, a first symbol 401 and a second symbol 402 have respective refractive indices n₁, and n₂. Assuming that refractive index n₁ is lower than refractive index n₂, symbol 401 travels faster through the fiber medium. There comes a point at which symbol 401 is a symbol length ahead of symbol 402. Assuming that the symbols 401, 402 are transmitted into the medium at the same time from the transmitter, the distance that symbol 401 has traversed at the instant it is one symbol length ahead of symbol 402 gives the unit skew (A).

The fiber length D can therefore be represented by Equation 3. In Equation 3, B is a constant that is equal to a skew distance attributable to the internal workings of the upstream transmitter (e.g., the OLT) and the downstream receiver (e.g., the ONU).

$$D = S * A + B \qquad Equation 3$$

In a case in which the symbols are not transmitted at the same time, the time difference between the symbols being transmitted may be converted to a corresponding number of symbols at the receiver and then subtracted from the index difference to give S.

Looking at the example of OLT 212 and ONU 230 of FIG. 2, the TDM PON downstream is implemented with two different wavelengths having distinct refractive indices n₁, n₂. When OLT 212 drives the discovery message with symbol markers for the alignment, the departure time at OLT 212 is the same or the time difference is a known factor (known skew at OLT, Ts0). In one example, OLT 212 advertises the known parameters like Ts0 and refractive index difference (Delta_n), and ONU 230 calculates the fiber length (D) with the parameters received from OLT 212 and its own local skew factors (part of B). The ONU 230 may use any of Equations 1-3 or other appropriate equations to estimate the fiber length (D) by taking into account the skew seen at its buffer as well as received parameters and known parameters.

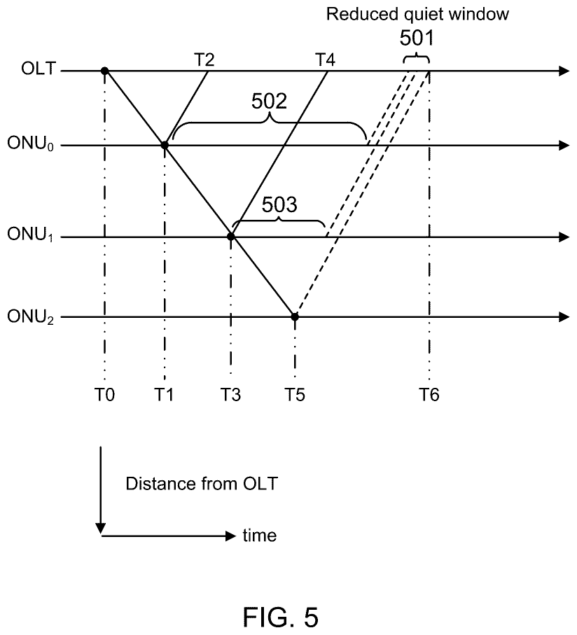

Continuing with the example, OLT 212 announces a max-distance parameter when it tries to discover new ONUs, such as ONU 230. ONU 230 receives the max-distance parameter (e.g., 20 km) and adjusts a preliminary equalization delay to have a virtual distance aligned to this max-distance. However, the precision of distance calculated with skew information is limited. It should be regarded as a preliminary equalization delay. Nevertheless, the uncertainty window size is materially reduced, as illustrated by FIG. 5.

The uncertainty window size is represented by the reduced quiet window 501, which is substantially smaller than the quiet window of FIG. 1. ONU₀ estimates its corresponding fiber length and then sets a preliminary equalization delay 502. In other words, ONU₀ uses its estimate of fiber length to set preliminary equalization delay 502 so that it transmits its response message between times T5 and T6 and specifically so that its response message is received at OLT within the reduced quiet window 501 and relatively close to time T6. Similarly, ONU₁ calculates its respective fiber length estimate and then sets preliminary equalization delay 503 so that its response message is received during the reduced quiet window 501. ONU₂ does the same, and its preliminary equalization delay may be close to zero or near zero and is not shown here for ease of illustration.

Some example embodiments may allow for a granularity of the fiber length estimate to be 100 m or so. In other words, the example embodiment above, which uses skew to estimate fiber length for a given downstream optical network device, may reduce the uncertainty by about two orders of magnitude. Reducing the uncertainty by about two orders of magnitude may allow the reduced quiet window 501 to be roughly two orders of magnitude smaller than the quiet window of FIG. 1. Of course, some embodiments may employ a randomized delay for response by each of the ONU devices, thereby allowing each of the ONU devices to respond without colliding with a response from another of the ONU devices. This example does not illustrate the use of randomized delays, but a range of randomized delays may be added to the reduced quiet window 501 as appropriate.

The example above, including Equations 1-3, uses a skew at a downstream optical network device to generate an estimate of fiber length. The estimated fiber length may then be used to calculate preliminary equalization delays, thereby reducing a quiet window. The scope of implementations includes any appropriate technique for acquiring an estimate of fiber length.

Another example technique for acquiring an estimate of fiber length may include observing power attenuation of the discovery message and estimating fiber length therefrom. The OLT does its transmitted power information and may include that transmitted power information in the discovery message. The ONU measures the received power of the discovery message. The ONU may compare the transmitted power to the received power to estimate the length of the fiber. Such technique may include additional information in the discovery message, such as a split ratio. A split ratio may be affected by the number of splitters and the number of splits in each of the splitters along the fiber length between the OLT and the ONU. In one example each split may cause a 3 dB decrease in signal power, but that may be different in other networks. The power attenuation expected for the fiber media itself may have a linear relationship with length, and the attenuation factor may be programmed into the ONU or transmitted by the OLT in the discovery message. In other words, there may be a constant and known decibel decrease attributable to splits as well as a component of attenuation that is proportional to the fiber length. When the ONU has that information as well as received and transmitted power information, it may estimate fiber length. The ONU may then use that estimated fiber length to generate a timing for its response message.

Yet another technique to acquire an estimate of fiber length may include using known installation information, assuming it is available. For instance, a network installer may know approximate fiber lengths to each of the downstream optical network devices from installation. The OLT may be programmed and have a database of ONU serial numbers matched with respective approximate fiber lengths. The discovery process may then include the OLT broadcasting a discovery message having information including at least one ONU serial number matched with a corresponding approximate fiber length. The ONU having that particular serial number may then use the approximate fiber length to generate a timing for its response message. In some embodiments, a discovery message may include serial numbers and approximate fiber lengths for multiple ONU devices.

Any other appropriate techniques for estimating fiber length may be used with various embodiments. Furthermore, various embodiments may combine multiple techniques for estimating fiber length or use only one technique to estimate fiber length. Additionally, or alternatively, some implementations may seek to reduce the randomized delay that may be added to an equalization delay by any of the downstream optical network devices. As noted above, a randomized delay may be used at each of multiple downstream optical network devices so that the response messages from each of those devices do not collide at the upstream optical network device. Usually, the maximum amount of randomized delay may be determined at least in part based on a number of downstream optical network devices to be discovered such that a higher number of downstream optical network devices may lead to a higher maximum amount of randomized delay. In one example, 16 downstream optical network devices at roughly a similar fiber distance may be associated with a maximum randomized delay set at 48 μs. Each one of the 16 downstream optical network devices would then have a randomized delay somewhere between 0 μs and 48 μs. However, 48 μs may be too much of a delay for some applications.

Therefore, some implementations of the present disclosure may reduce the maximum randomized delay. In one example, the maximum randomized delay may be reduced by reducing the quantity of downstream optical network devices that might respond to a given discovery message. For instance, the upstream optical network device (e.g., the OLT) may know in advance the serial numbers of the downstream optical network devices (e.g., the ONUs) to be discovered. The upstream optical network device may then broadcast the discovery message to include an indication that only even-numbered serial number devices are to respond and then in a subsequent discover operation include an indication that only odd-numbered serial number devices are to respond.

A downstream optical network device may parse the discovery message, determine that it is (or is not) part of a group to be discovered and then respond (or not) accordingly. Assuming that the number of devices to respond at any given time may be reduced by half, then the maximum randomized delay may then also be reduced by half. Further reductions may include performing a hashing algorithm on the serial numbers and using that hashing algorithm to break down the total number of downstream optical network devices into four groups, eight groups, or the like. The maximum randomized delay may then be reduced to one quarter, one eighth, or the like.

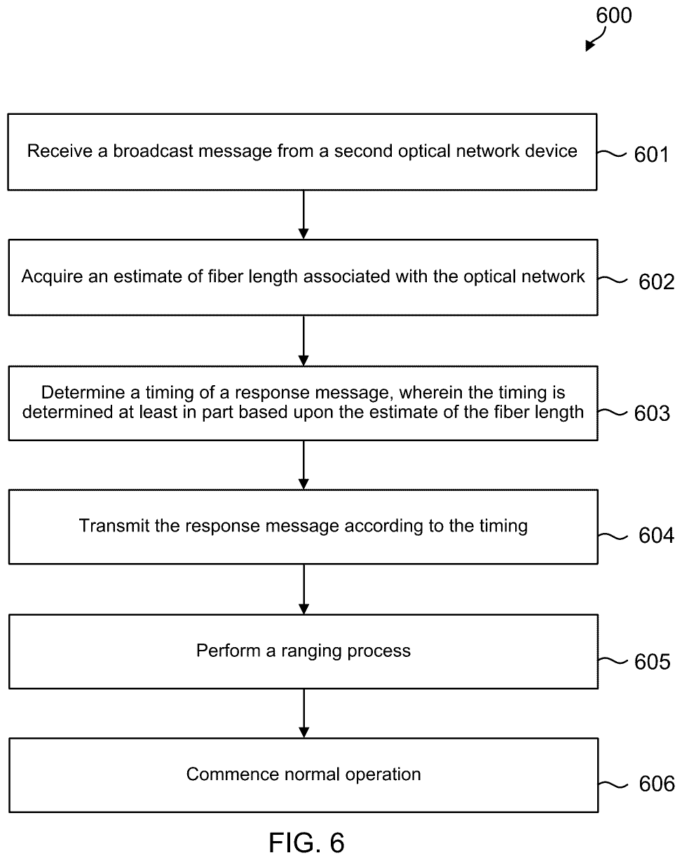

FIG. 6 is an illustration of an example method 600, according to one implementation. Method 600 may be performed by a downstream optical network device, such as an ONU. More specifically, method 600 may be performed by a computing device, which is part of a downstream optical network device, where the computing device reads and executes computer readable instructions from a computer readable medium, and the computer readable instructions cause the downstream optical network device to perform the actions.

At action 601, a first optical network device receives a broadcast message from a second optical network device. For instance, the first optical network device may be a downstream optical network device, and the second optical network device may be an upstream optical network device, such as an OLT. The OLT may broadcast a discovery message over an optical network, such as a PON, as illustrated in FIG. 2 and FIG. 5.

At action 602, the first optical network device acquires an estimate of fiber length associated with the optical network. As described above, there are various techniques that may be used to acquire an estimate of fiber length. One example technique includes measuring skew associated with multiple different wavelengths each associated with a distinct refractive index and then using that skew measurement to calculate a preliminary fiber length.

In another example, the first optical network device may use a difference in transmitted power and received power in the discovery message to estimate the optical fiber length. In yet another example, the first optical network device may use information included within the discovery message, such as an indication of an approximate fiber length, as a fiber length estimate. Other appropriate techniques may be used instead of or in addition to the examples above.

At action 603, the first optical network device determines a timing of a response message. The timing may be determined at least in part based upon the estimate of the fiber length. For instance, the first optical network device a calculate a preliminary equalization delay, which times the transmission of the response message so that receipt of the response message at the second optical network device occurs at or around a particular time. For instance, the preliminary equalization delay may cause the response message to be received at the second optical network device at a time corresponding to a maximum network distance (e.g., corresponding to a maximum distance of 20 km or other appropriate distance).

Of course, in some embodiments, the time window may be a shortened time window that either does or does not accommodate a randomized delay. As noted above, randomized delays may be applied by a given downstream optical network device to avoid collision. The time window may be increased to accommodate the randomized delay (or not). In any event, the result is that the quiet window is a shortened time window, such as shown in FIG. 5, which is shorter than the quiet window of FIG. 1. The quiet window shown in FIG. 5 is shorter than the FIG. 1 quiet window because the uncertainty of the timing of receipt of the response message has been reduced through use of the preliminary fiber length determination.

In another embodiment, the actions 602 and 603 may be combined so that the fiber length is not explicitly calculated. For instance, the first optical network device may be programmed so that it uses the observed skew index as a key to search a database of skew index entries. Each of the skew index entries may have a corresponding preliminary equalization delay. The first optical network device may then search the database to reach the appropriate entry and then use the corresponding preliminary equalization delay for transmission of the response message. Also in this embodiment that combines actions 602 and 603, the first optical network device may be programmed so that it matches a signal power attenuation and/or received fiber length data to a corresponding preliminary equalization delay.

At action 604, the first optical network device transmits the response message according to the timing. For instance, the first optical network device may transmit the response message with the appropriate preliminary equalization delay. Action 604 may also include transmitting with an additional randomized delay or not.

At action 605, the first optical network device performs a ranging process. The ranging process may be a two-way ranging process performed with the second optical network device. An example ranging process may include one or more exchanges between the first optical network device and the second optical network device to determine an appropriate equalization delay for the first optical network device. The ranging process of action 605 may generate a determination of the fiber length having more accuracy than the estimate at action 602. The ranging process of action 605 may generate a determination of the fiber length having less uncertainty than the estimate at action 602. Furthermore, the equalization delay determined from the ranging process may be more precise than the timing of action 604 by an order of magnitude or more. In other words, the actions 601-604 may generate a timing that is coarse, whereas action 605 may be fine.

At action 606, the first optical network device commences normal operation. In other words, at action 606 discovery has been performed and completed, and mission mode operation has been started. The first optical network device may then communicate with the second optical network device using an equalization delay determined by the ranging process of action 605. Normal operation may include transmission and reception of control and data between the first optical network device and the second optical network device.

The scope of implementations is not limited to the series of actions illustrated in FIG. 6. Rather, other embodiments may omit, rearrange, modify, or add one or more actions. For instance, method 600 may be performed by other optical network devices as they are discovered by the second network device. Additionally, discovery operations may be performed as needed, such as when the optical network is maintained or repaired, as optical network devices are repaired or replaced, and the like.

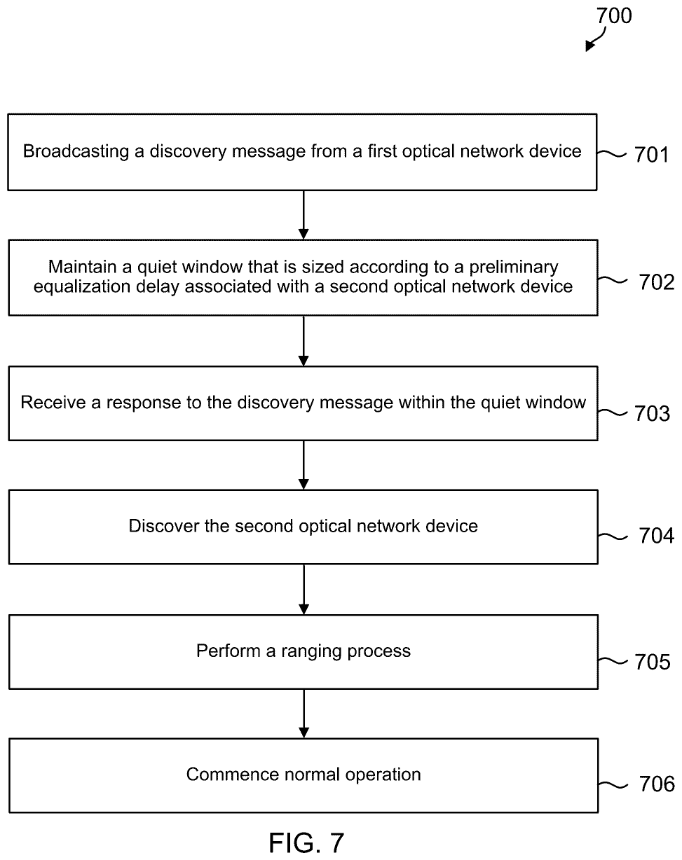

FIG. 7 is an illustration of an example method 700, according to one implementation. Method 700 may be performed by an upstream optical network device, such as an OLT. More specifically, method 700 may be performed by a computing device, which is part of an upstream optical network device, where the computing device reads and executes computer readable instructions from a computer readable medium, and the computer readable instructions cause the upstream optical network device to perform the actions.

At action 701, the first optical network device may broadcast the discovery message. In this example, as contrasted with the example of FIG. 6, the first optical network device may include an upstream optical network device (e.g., OLT), and the second optical network device may include a downstream optical network device (e.g., ONU).

The discovery message at action 701 may include any appropriate information. The discovery message may include information regarding serial numbers of devices and approximate fiber lengths, attenuation information and split ratios, indices of refraction, transmission timing information, indication of response groups and randomization delays, or the like.

At action 702, the first optical network device maintains a quiet window. The quiet window is sized according to a preliminary equalization delay associated with a second optical network device. For instance, the quiet window may be sized to assume that the equalization delay will virtually place the second optical network device at a maximum network distance affected by some amount of uncertainty. In an example, the quiet window is sized to assume that the equalization delay places the second optical network device virtually at 20 km with between 10 μs and 20 μs of uncertainty, which is consistent with the example of FIG. 5. Of course, that is just an example, and the scope of embodiments is not limited to any particular maximum network distance or amount of uncertainty. In any event, the amount of uncertainty that defines the quiet window is less than the full range of uncertainty from time T2 to time T6 in FIG. 1.

An example of a preliminary equalization delay is given above with respect to actions 602-604 of FIG. 6.

At action 703, the first optical network device receives a response to the discovery message within the quiet window. An example is shown in FIG. 5, in which the responses from the ONUs are transmitted with preliminary equalization delays and are all received within the reduced quiet window 501.

At action 704, the first optical network device discovers the second optical network device. Specifically, there may be a discovery process in which the first optical network device discovers and saves various characteristics associated with the second optical network device, such as confirming a serial number, confirming proper operation, and the like. Any appropriate discovery process may be performed in various embodiments.

At action 705, the first optical network device and the second optical network device perform a ranging process. An example ranging process is described above with respect to action 605. Any appropriate ranging process may be performed.

Action 706, the first optical network device and the second optical network device commence normal operation. An example of commencing normal operation is described above with respect to action 606.

The scope of implementations is not limited to the series of actions illustrated in FIG. 7. Rather, other embodiments may omit, rearrange, modify, or add one or more actions. For instance, method 700 may be performed as other optical network devices are discovered. Additionally, discovery operations may be performed as needed, such as when the optical network is maintained or repaired, as optical network devices are repaired or replaced, and the like.

Various implementations may include one or more advantages. The quiet window determined by the uncertainty and additional randomization is significantly reduced in FIG. 5 verses in FIG. 1. Quiet window reduction may increase efficiency of the network by reducing time for traffic restrictions and increasing time for other traffic. Reduction in the quiet window may also reduce an amount of delay seen by applications, such as 5G applications or applications that require lower latency. In some examples, the reduction of the quiet window may reduce the delay to a level that is acceptable to some applications, thereby increasing the quantity and types of applications that may be supported by the network.

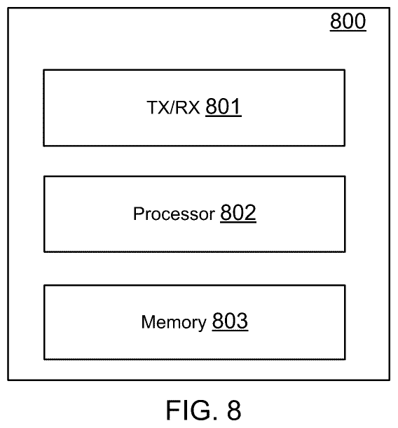

FIG. 8 is a simplified block diagram of an example optical network device 800, such as may be used in various embodiments of the disclosure. For instance, the optical network device 800 is a simplified illustration of an ONU, an OLT, or other appropriate network device.

Optical network device 800 includes a transceiver 801, which is configured to transmit and receive optical signals over an optical network. An example of an optical network is shown in FIG. 2, it includes one or more optical fiber connections, such as illustrated in FIG. 3.

Processor 802 is configured to control the transceiver 801. The processor 802 may include any appropriate processing device, such as may be implemented on one or more semiconductor dies. Examples of implementations of processor 802 may include an application-specific integrated circuit, general-purpose processor, reduced instruction set processor, or the like. The processor 802 may read computer executable code from the memory 803 and then execute that computer-executable code. The computer executable code may provide the functionality described above with respect to FIGS. 6-7. Memory 803 may be a non-transitory readable medium, such as random-access memory, a solid-state drive, and/or the like. In some implementations, the memory may be included within the processor 802 or may be implemented separate from the processor 802.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A first optical network device comprising:
an optical transceiver;
a computing device in communication with the optical transceiver and configured to control transmission and reception at the optical transceiver;
a memory storing computer readable media having computer executable code, which when executed by the computing device, causes the first optical network device to:
receive a broadcast message from a second optical network device through an optical network and via the optical transceiver;
acquire an estimate of fiber length associated with the optical network based on at least one of: a physical characteristic of the broadcast message or information carried by the broadcast message;
determine a timing of a response message to be sent by the first optical network device and to be received during a time window at the second optical network device, wherein the timing of the response message is determined at least in part based upon the estimate of the fiber length; and
transmit the response message via the optical transceiver to the second optical network device according to the timing.

2. The first optical network device of claim 1, wherein the computer readable media further includes computer executable code to cause the first optical network device to:
perform a round-trip ranging operation with the second optical network device subsequent to transmitting the response message, wherein the round-trip ranging operation generates a determination of the fiber length having more accuracy than does the estimate of the fiber length.

3. The first optical network device of claim 1, comprising an optical networking unit (ONU).

4. The first optical network device of claim 3, wherein the computer executable code to transmit the response message includes computer executable code to cause the first optical network device to transmit the response message to an optical line terminal (OLT).

5. The first optical network device of claim 4, wherein the optical network comprises a passive optical network (PON).

6. The first optical network device of claim 1, wherein the physical characteristic of the broadcast message includes a timing skew, and wherein the computer executable code to cause the first optical network device to acquire the estimate of the fiber length comprises code to:
measure the timing skew between two signals of the broadcast message; and
compute the estimate of the fiber length based at least in part on the timing skew.

7. The first optical network device of claim 1, wherein the physical characteristic of the broadcast message includes a difference between transmitted power and received power of the broadcast message, and wherein the computer executable code to cause the first optical network device to acquire the estimate of the fiber length comprises code to:
measure the difference between transmitted power and received power of the broadcast message; and
compute the estimate of the fiber length based at least in part on the difference between transmitted power and received power.

8. The first optical network device of claim 1, wherein the information carried by the broadcast message identifies the estimate of fiber length, and wherein the computer executable code to cause the first optical network device to acquire the estimate of the fiber length comprises code to:
parse the broadcast message, including identifying the estimate of the fiber length.

9. The first optical network device of claim 1, further comprising computer executable code, which causes the first optical network device to:
parse the broadcast message, including identifying information within the broadcast message that indicates that the first optical network device belongs to a first group, of a plurality of groups, of optical network devices to be discovered based on the broadcast message; and
determine to transmit the response message based at least in part on the information within the broadcast message that indicates that the first optical network device belongs to the first group.

10. A method performed by a first optical network device, the method comprising:
broadcasting a discovery message over an optical network, the optical network including a second optical network device that has not yet been discovered by the first optical network device;
maintaining a quiet window that is sized to accommodate a preliminary equalization delay associated with the second optical network device;
receiving a response to the discovery message from the second optical network device within the quiet window;
discovering the second optical network device; and
performing a ranging process, the ranging process having a second level of uncertainty that is lower than a first level of uncertainty associated with the preliminary equalization delay.

11. The method of claim 10, wherein the first optical network device comprises an optical line terminal (OLT), and wherein the second optical network device comprises an optical network unit (ONU).

12. The method of claim 10, wherein the quiet window is sized to assume the first level of uncertainty at a maximum network distance.

13. The method of claim 10, wherein the discovery message comprises two signals subject to a timing skew within the optical network.

14. A method performed by a first optical network device within an optical network, the method comprising:
receiving a broadcast message from a second optical network device, the broadcast message received over the optical network;
determining a preliminary equalization delay for the first optical network device based on at least one of: a physical characteristic of the broadcast message or information carried by the broadcast message; and
transmitting the response message from the first optical network device to the second optical network device according to the preliminary equalization delay.

15. The method of claim 14, further comprising:
performing a ranging process with the second optical network device, including determining a fiber length to a first level of uncertainty that is lower than a second level of uncertainty associated with the preliminary equalization delay.

16. The method of claim 14, further comprising:
acquiring an estimate of fiber length associated with the optical network based on at least one of: the physical characteristic of the broadcast message or the information carried by the broadcast message.

17. The method of claim 16, wherein determining the timing of the response message comprises:
determining the preliminary equalization distance based on the estimate of fiber length.

18. The method of claim 16, wherein performing the ranging process comprises:
setting an equalization distance for use subsequent to a discovery process, wherein the equalization distance is associated with a first level of uncertainty, and wherein the preliminary equalization distance is associated with a second level of uncertainty that is higher than the first level of uncertainty.

19. The method of claim 14, wherein the broadcast message is received as part of a discovery process performed by the second optical network device.

20. The method of claim 14, further comprising:
applying a randomized delay to the response message based at least in part on information received in the broadcast message.
